(19) United States
(12) Patent Application Publication
(10) Pub. No.: US 2012/0292275 A1
(43) Pub. Date: Nov. 22, 2012

(54) SHAKE AND SHINGLE SHELF

(76) Inventors: Dan R. DUQUETTE, Meredith, NH (US); Gerald F. BRIGGEMAN, Laconia, NH (US)

(21) Appl. No.: 13/471,569

(22) Filed: May 15, 2012

Related U.S. Application Data
(60) Provisional application No. 61/486,895, filed on May 17, 2011.

(51) Int. Cl. A47B 96/02; B23P 17/00

(52) U.S. Cl. 211/90.01; 29/428

(57) ABSTRACT

A temporary shelf system for supporting a load along a wall having overlapping horizontal rows of siding members. The shelf system comprises a pair of shelf jigs, and each shelf jig comprises a planar main body which has at least an upper portion and front and rear faces, a planar support plate fixedly supported by the main body and extending approximately normal to the front face of the main body, and a retention spring extending from the main body substantially parallel to the support plate. A portion of the retention spring is spaced from the support plate so as to apply a clamping force to a shelf board when the shelf board is located between the retention spring and the top surface of the support plate and facilitate retention of the to the shelf board.

This application claims priority from U.S. Provisional Application No. 61/486,895 filed on May 17, 2011.

### FIELD OF THE INVENTION

The present invention relates to a shake and shingle shelf to be supported by a vertically oriented wall and, more particularly, to a shake and shingle shelf that is removably supported between siding elements, such as conventional shakes and shingles, so as to provide a worker with a conveniently located temporary shelf on upon which building materials, supplies and/or tools can be placed during the installation of shakes, shingles, clapboards and/or the siding material or when performing maintenance or repair.

### BACKGROUND OF THE INVENTION

At the present time there are no known commercial or residential temporary shelving upon which a worker may store building materials, supplies and/or tools during the installation of shakes, shingles, clapboards and/or the siding material or when performing maintenance or repair on a building or other structure. As is well known in the art, conventional staging is typically used during the installation, maintenance and/or repair of siding. Such staging is generally assembled adjacent to the exterior wall of the structure on which siding is in the process of being installed or other maintenance or repair work being performed. Generally, such conventional staging generally comprises a plurality of interconnected or linked frame members coupled together to form a framework upon which temporary platform members, such as sheets of plywood or planks for example, are then located at desired location on the framework. This staging provides a support platform on which both the workers can stand while installing or repairing/replacing siding and building materials, supplies and/or tools can be stored. Although such staging may be helpful in the installation of siding, the worker is still required to bend over or down or turn around in order to pick up the needed building materials, supplies and tools. Repeated bending over and picking up or restocking of building materials and/or supplies by the worker is generally not convenient and consequently reduces the rate at which the worker can install the siding or otherwise perform the repair work.

### SUMMARY OF THE INVENTION

Wherefore, it is an object of the present invention to overcome the above-mentioned shortcomings and drawbacks associated with the prior art by providing a conveniently located temporary shelving system on upon which building materials, supplies and/or tools of a worker(s) can be placed during the installation of shakes, shingles, clapboards and/or the siding material or when performing maintenance or repair on a building or structure.

Another object of the invention is to provide a shelving system having a tool or jig that allows a worker to locate a shelf conveniently in front of and above the location where the worker is currently working, thereby minimizing time and disadvantage otherwise involved in picking up needed building materials, supplies and/or tools during installation or when performing maintenance or repair. The shelving system of the present invention is easy to install and use and facilitates rapid installation of siding by helping to organize the siding materials and/or tools used during in the process of installing such siding.

A further object of the present invention is to provide a tool or jig that is easy to install and remove from existing overlapped siding of a building or other structure. The inventive shelving system is simply installed by slipping a leading end of the tool or jig between two adjacent overlapped horizontal rows of installed shakes, shingles, and/or clapboards and/or some other siding materials so as to thereby reliably facilitate retention of the shelving system to a desired sidewall.

Yet another object of the present invention is to provide a tool or jig having a mechanism that furnishes a convenient place to place or hang a nail gun(s), a jig saw(s), or any other tool or associated installation equipment or building supplies or materials which may be utilized during the installation of shakes, shingles, clapboards and/or the siding material to a building or other structure or when performing maintenance or repair on a building or structure.

A further object of the present invention is to provide a shelving system that includes a shelf jig that is a one-piece non adjustable body having vertically upper and lower portions. The upper portion of the jig body facilitates reliable retention of the shelf jig to the sidewall when the upper portion of the main body is inserted between two overlapping horizontal rows of shakes. Fixed to the lower portion of the main body is a support plate, a shelf retention spring and diagonal brace member. The purpose of the support plate is to support a shelf member. The retention spring is fixed to the lower portion of the main body at a desired distance above the support plate. The retention spring is formed and located so as to apply a suitable tension or compressive force onto the shelf member thereby securing the shelf member against the support plate. The diagonal brace member is located below the support plate with one edge being fixed to the main body and another edge being fixed to the bottom of the support plate so as to enhance the strength and rigidity of the support plate. The diagonal brace member may comprise an aperture to assist with easy insertion and removal of the shelf jig from between two overlapping horizontal rows of shakes. The diagonal brace member may also have a tool hook to provide a convenient place to secure or hang tools which may be used in the installation of sidewall shakes.

The present invention also relates to a shelf system for supporting a load along a wall that has overlapping horizontal rows of siding members. The shelf system comprises a pair of shelf jigs, and each of the shelf jigs comprise an elongate planar main body and an elongate planar support plate. One end of the support plate is integral with the main body and the support plate extends at least substantially normally from the main body. A shelf board is supported by the support plates of the pair of shelf jigs to form a shelf.

The present invention also relates to a shelf system for supporting a load along a wall having overlapping horizontal rows of siding members. The shelf system comprises a pair of shelf jigs, and each of the shelf jigs comprises a planar main body that has at least an upper portion and front and rear faces. A planar support plate that is fixedly supported by the main body and extends approximately normal to the front face of the main body. A retention spring is fixed to and extends from the front face of the main body substantially parallel to the support plate. An end of the retention spring that is remote from the main body is closer to the support plate than an end of the retention spring that is fixed to the main body such that the remote end of the retention spring applies a clamping force to a shelf board when the shelf board is located between the retention spring and the support plate to facilitate retention of the shelf board

The present invention also relates to a method of supporting a load with a shelf system along a wall having either shake or shingle siding. The shelf system comprises a shelf board and at least a pair of shelf jigs and each of the shelf jigs has a planar main body with upper and lower ends and front and rear faces. A planar support plate is fixed at an approximately normal angle to the front face of the main body. A brace member that has a first edge fixed to a bottom surface of the support plate and a second edge that is fixed to the front face of the main body to brace the support plate with respect to the main body. A retention spring that is fixed to the front face of the main body between a top surface of the support plate and the upper end of the main body. The method comprises the steps of laying at least the upper end of the main body of a first shelf jig on an outer face of at least one lower shake of a lower row of shakes such that a rear face of the main body is substantially flush and parallel with an outer face of the at least one lower shake. Subsequently, inserting the upper end of the main body between an inner face of at least one upper shake of an upper row of shakes and the outer face of the at least one lower shake by sliding the first shelf jig along the outer face of the at least one lower shake toward the at least one upper shake until the upper end of the main body is secured between the at least one upper shake and the at least one lower shake. Laying at least the upper end of the main body of a second shelf jig on an outer face of at least one other lower shake of the lower row of shakes laterally spaced from the first shelf jig such that a rear face of the main body of the second shelf jig is substantially flush and parallel with an outer face of the at least one other lower shake. Subsequently, inserting the upper end of the main body of the second shelf jig between an inner face of at least one other upper shake of the upper row of shakes laterally spaced from the first shelf jig and the outer face of the at least one other lower shake by sliding the second shelf jig along the outer face of the at least one other lower shake toward the at least one other upper shake until the upper end of the main body of the second shelf jig is secured between the at least one other upper shake and the at least one other lower shake. Then inserting the shelf board between the retention springs and the top surface of the support plates of the first and the second shelf jigs.

By providing the worker(s) with a shelving system, at a convenient location, which supports needed building materials, supplies and/or tools during installation or when performing maintenance or repair, the shelving system of the present invention provides a safer and more organized work area for the worker during the installation of shakes, shingles, and/or clapboards and/or some other siding materials on the sidewall(s) of the building or other structure and also improves safety during such installation, maintenance and/or repair situations.

As used herein, the term siding materials is to be understood to mean any type of available wood, composite or manufacture shakes, shingles, clapboards, etc., (composite meaning any concrete fiber, plastic or any other artificial material). As such, the terms siding materials and shakes, shingles and/or clapboards are utilized interchangeably in the following description and appended claims relating to the shelving system.

### BRIEF DESCRIPTION OF THE DRAWINGS

The invention will now be described, by way of example, with reference to the accompanying drawings in which:

FIG. 1 is a diagrammatic perspective view of the shelf jig of the shelving system according to the present invention;

FIG. 2 is a diagrammatic front elevation view of the shelf jig of FIG. 1;

FIG. 3 is a diagrammatic side elevation view of the shelf jig of the shelf jig of FIG. 1;

FIG. 3a is a diagrammatic side elevation view of the shelf jig, of FIG. 1, engaged between shakes of two overlapped rows of shakes and a shelf retained by the shelf jig;

FIG. 3b is a diagrammatic side elevation view of the shelf jig of the shelf jig of FIG. 1;

FIG. 4 diagrammatically shows a pair of spaced apart shelf jigs, according to FIG. 1, on a portion of a wall having shake siding, with the pair of shelf jigs installed along a desired row of shakes and wood shelf board supported on and retained by the pair of spaced apart shelf jigs;

FIG. 5 is a diagrammatic perspective view of a further embodiment of the shelf jig of the shelving system according to the present invention; and

FIG. 6 is a diagrammatic perspective view of a still further embodiment of the shelf jig of the shelving system according to the present invention.

### DETAILED DESCRIPTION OF THE INVENTION

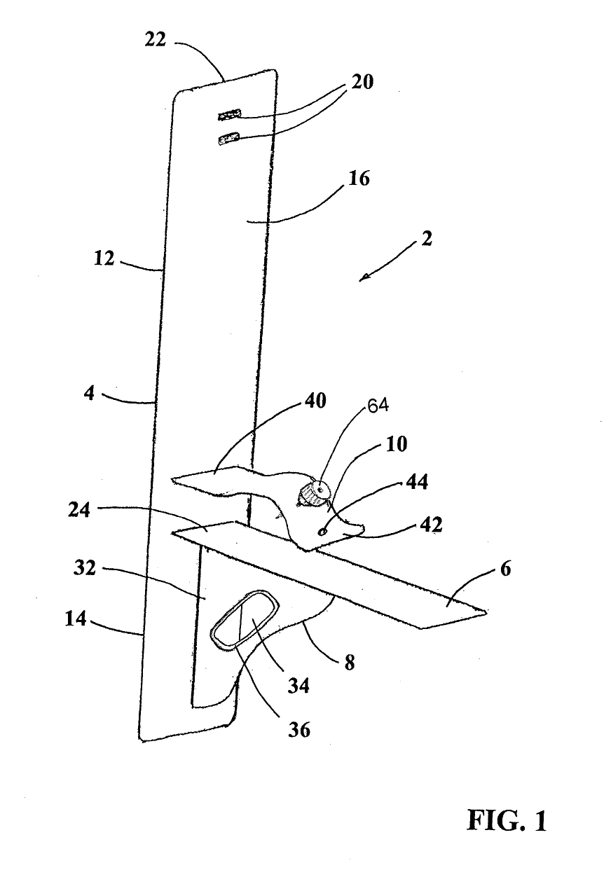

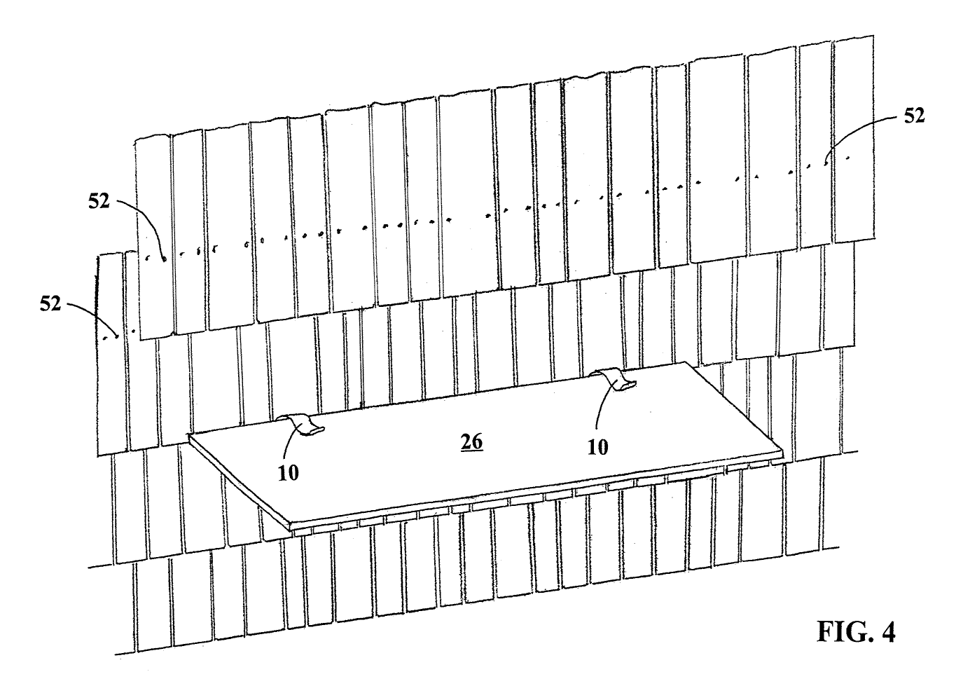

Turning now to FIGS. 1-4, a brief description concerning the various components of shelf system, according to the present invention, will now be provided. As discussed below in further detail, the shelving system generally comprises two or more identical, or substantially identical, shelf jigs 2 (see FIG. 4). The embodiment the shelf jig 2, as shown in FIG. 1, comprises a generally vertically oriented main body 4, a support plate 6 which extends substantially normally to and from an intermediate region of the main body 4, a brace member 8, providing additional support for the main body 4, and a shelf retention spring 10, which also extends substantially normally to and from the main body 4 and cooperates with the support plate 6.

The main body 4 of the shelf jig 2 is generally an elongate, relatively thin planar plate member having an upper portion 12 and a lower portion 14. The main body 4 also has two opposed faces, i.e., a substantially planar front face 16 and a substantially planar rear face 18. The upper portion 12 of the main body 4 comprises one or more gripping protrusions 20 located on at least one of the front and/or rear faces 16, 18 of the main body 4 adjacent an upper end 22 of the main body 4 so that the upper portion 12, of the main body 4, may function as a clamping leg, during use as will be discussed below in further detail.

The lower portion 14 of the main body 4 serves as the structural base for the support plate 6, the retention spring 10 and the brace member 8. The support plate 6 is an elongate planar plate member having a first end 24 that is rigidly fixed or connected with an intermediate region of the front face 16 of the main body 4 in the lower portion 14. The support plate 6 extends from the main body 4 generally at an angle of 90 degrees. The upper top surface of the support plate 6 is substantially planar and, during use, functions for directly supporting a desired shelf board 26.

The shelf jig 2 typically has a width of between ¼ inch to about 5 inches or so, and more preferably has a width of between about 1 inch to about 2 inches or so. The main body 4, the support plate 6 and the brace member 8 typically have a thickness of between about 1/32 inch to ⅛ inch and more preferably about 1/16 inch or so. The shelf jig 2 typically has an overall length of between 3 inches to about 12 inches or so and more preferably a length of between 7 inches to 10 inches or so.

The brace member 8 is a generally triangularly shaped planar plate having a vertical first edge 28 fixedly secured, in a conventional manner such as by glue, welding, fasteners, etc., to the bottom surface 30 of the support plate 6 and a horizontal second edge 32 fixedly secured, in a conventional manner such as by glue, welding, fasteners, etc., to the front face 16 of the main body 4. With such arrangement, the brace member 8 enhances the overall rigidity and integrity of the support plate 6 with respect to the main body 4. Further, the brace member 8 functions to distribute the weight of the shelf board 26 and any load being supported by the shelf board 26 to the main body 4 and the building or other structure. It is to be appreciated that a variety of other types, shapes and/or sizes of brace members 8 can be utilized so long as such brace adequately reinforces and supports the support plate 6.

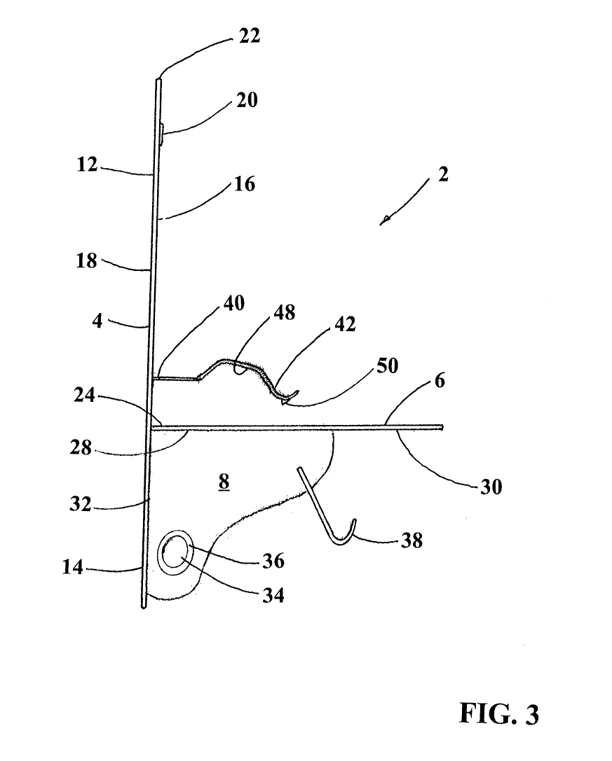

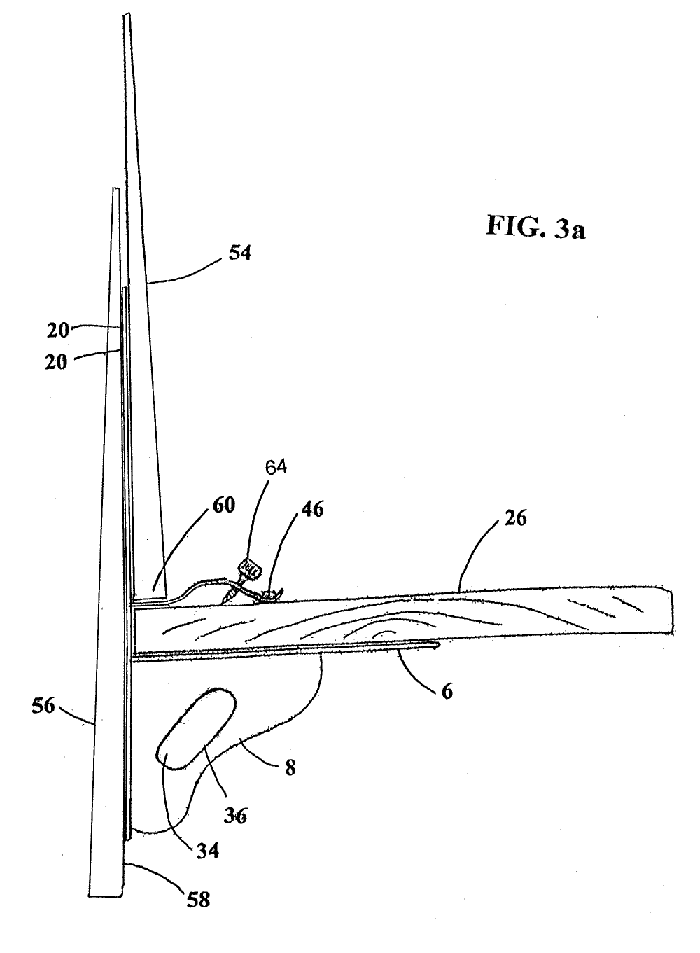

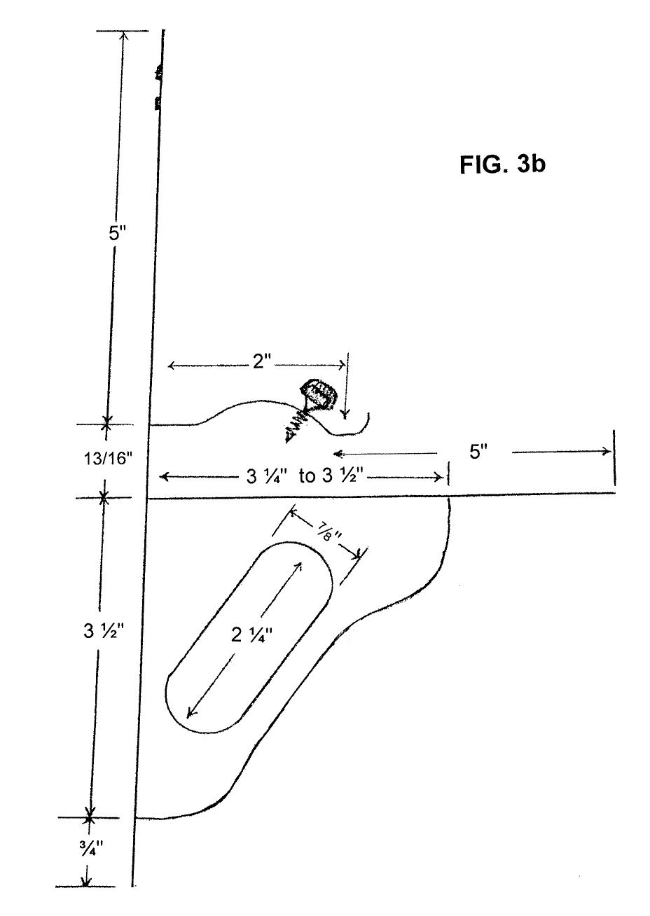

In the embodiment shown in FIGS. 1, 3 and 3A, the brace member 8 includes an aperture 34 (or any other conventional insertion/retraction feature or element such as a knob, handle, etc.) which can be used to assist with insertion and extraction of the shelf jig 2, e.g., insertion/removal of the upper portion 12 of the main body 4 from between two overlapping rows of shakes or other siding members (see FIG. 3). Although the aperture 34, or any other conventional insertion/retraction feature or element as shown in FIGS. 1, 3 and 3A, is shown on a lower portion of the brace member 8, it is to be appreciated that the aperture 34, or any other conventional insertion/retraction feature or element, may be located essentially anywhere along the brace member 8, on the lower portion 14 of the main body 4 and/or on the support plate 6. The important aspect is that the aperture 34, or any other conventional insertion/retraction feature or element, be located so as to be easy accessible by a worker to facilitate manipulate of the shelf jig 2 as described below in further detail, e.g., the worker inserts his/her finger into the aperture 34 or otherwise grasps the other conventional insertion/retraction feature or element. To minimize irritation/discomfort to the finger of the worker often associated with sharp edges, both opposed parameter edges of the aperture 34, or any other conventional insertion/retraction feature or element, may be rounded or beveled or possibly coated with a protective layer or material 36. It is to be appreciated that the aperture 34 can be of different sizes and/or shapes. These differences can be seen in for example in FIGS. 1 and 3.

In the embodiment as shown in FIG. 3, the brace member 8 may support one or more attachment features or elements, such as a hook 38. The hook 38 is supported via a hole or some other conventional element of the brace member 8 and has a portion that is generally U-shaped so as to facilitate receiving and retaining an electrical cable(s) or pneumatic hose(s) that may be connected to a nail gun, a jig saw or some other conventional tools utilized during installation or when performing maintenance or repair.

FIG. 3b illustrates the shelf jig 2 as having noted dimensions, however it is to be appreciated that the dimensions of the various elements of the shelf jig 2 can be different depending on the application of the shelf jig 2. For example, a shelf jig which is to be used to support greater weights may have dimensions larger than those specified in the figure. A first end 40 of the retention spring 10 is fixedly secured, in a conventional manner such as by glue, welding, fasteners, etc., to the front face 16 of the main body 4 in spaced relationship with respect to the upper surface of the support plate 6. As noted above, the retention spring 10 extends generally parallel to the support plate 6 and perpendicular to the main body 4. The spacing between the first end 40 of the retention spring 10 and the support plate 6 is preferably between ¾ inches to 1¼ inches, and more preferably approximately 13/16 inch. Although the spacing between the first end 40 of the retention spring 10 and the support plate 6 is not critical, it is to be appreciated that this the distance should be large enough to readily receive and accommodate a desired shelf board 26 between the retention spring 10 and the support plate 6. That is, the spacing between the first end 40 of the retention spring 10 and the support plate 6 should be at least as large as the thickness of the desired shelf board 26 so as not to interfere the shelf board 26 being received between the retention spring 10 and the support plate 6.

The retention spring 10 is formed such that a second end 42 of the shelf retention spring 10, remote from the front face 16 of the main body 4, is sufficiently spaced from the upper surface of the support plate 6 by a distance somewhat smaller than the thickness of the desired shelf board 26 so as to assist with providing a desired clamping force to the shelf board 26 when located between the retention spring 10 and the support plate 6. A portion of the retention spring 10, adjacent the second end 42 of the retention spring 10 and the support plate 6 being at least as large as the thickness of the desired shelf board 26 while an intermediate location along the retention spring 10 has a spacing, from the support plate 6, which is smaller than the thickness of the desired shelf board 26. As a result of such arrangement, the retention spring 10 generally flexes, as the desired shelf 26 is received between the retention spring 10 and the support plate 6, and applies a clamping/retaining force on the shelf board 26 which firmly clamps the shelf board 26 to the support plate 6. To facilitate receiving the shelf board 26 by the retention spring 10, the leading second end 42 of the shelf retention spring 10 is curved or bent upward, away from the support plate 6, as best shown in FIG. 3. Such bend or curvature facilitates easy insertion of the shelf board 26 between the retention spring 10 and the support plate 6. Although the retention spring 10, as shown in FIG. 3, is formed so as to have an approximately arcuate side profile, it is to be understood that the retention spring 10 can be configured in any desired manner as long as the retention spring 10 applies a suitable clamping force to the shelf board 26, once inserted between the retention spring 10 and the support plate 6.

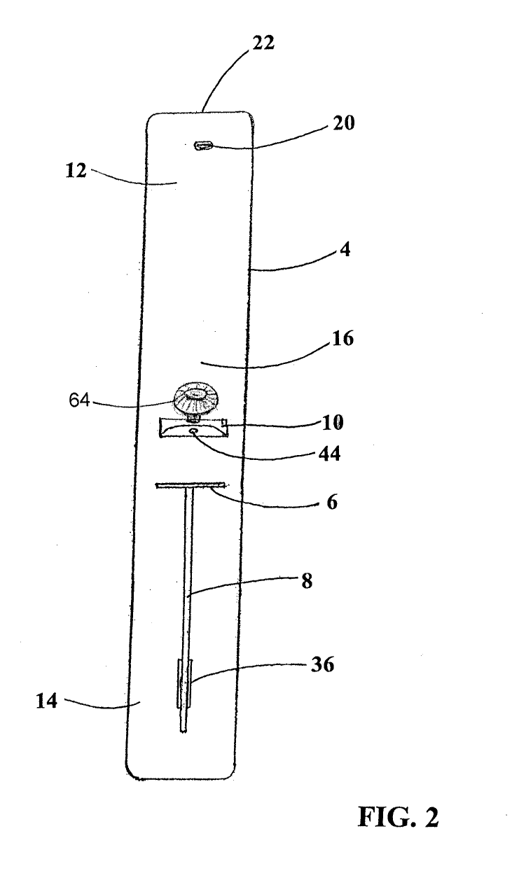

As shown in FIGS. 1 and 2, the remote end 42 of the shelf retention spring 10, or possibly the support plate 6, may include one or more pre-drilled holes 44. Such pre-drilled holes 44 facilitate securely fastening the shelf board 26 to the shelf jig 2 via a conventional fastener. For example, following insertion of the shelf board 26, between the retention spring 10 and the support plate 6, a conventional fastener such as a screw or a nail 46, can be used to secure the shelf board 26 to the retention spring 10 or the support plate 6. It is also conceivable that the shelf board 26 could be secured to the shelf jig 2 by a threaded screw knob 64. In this case, following insertion of the shelf board 26, between the retention spring 10 and the support plate 6, the threaded screw knob 64 could be rotated thus driving the point of the screw knob 64 into the shelf board 26. The screw knob 64 is retained in the retention spring 10 by threaded engagement therewith or by way of a locking washer. As shown in FIG. 3a the threaded screw knob 64 is arranged at an angle with respect to the support plate 6 such that the point of the threaded screw knob 64 is directed toward the main body 4. Preferably the screw knob 64 is approximately at a 45 degree angle with respect to the shelf board 26 and the support plate 6. With the screw knob 64 at such an angle, when the screw knob 64 bites into the shelf board 26, the screw knob 64 retains the shelf board 26 in position and keeps the shelf board 26 from backward movement away from the main body 4.

The upwardly facing horizontal surface 48 of the retention spring 10, e.g., adjacent the remote end 42 thereof for example, may have one or more sharp teeth, barbs or some other similar feature(s) 50 which are angled such that the shelf board 26 could easily be inserted between the retention spring 10 and the support plate 6, but when an attempt is made to withdraw the shelf board 26 therefrom, the sharp teeth, barbs or other similar feature(s) 50 tend to engage with the shelf board 26 and prevent the inadvertent withdrawal thereof. In this case, the retention spring 10 would typically have to be bent or otherwise biased away from the support plate 6 before the shelf board 26 could be withdrawn from the sharp teeth, barbs or other similar feature(s) 50.

Installation and use of shelf jig 2, according to the present invention, will be now be described with reference to FIGS. 3A and 4. When a situation arises where utilization of the shelf would be useful and convenient, the worker inserts the upper portion 12 of the main body 4 of the shelf jig 2 between the shakes, shingles, clapboards and/or the siding material of two adjacent overlapping horizontal rows of shakes, shingles, clapboards and/or the siding material (see FIG. 3A). For convenience, the following description will hereafter refer only to shakes, however it is to be understood that the shelving system could be utilized in the same manner with shingles, clapboards or the like. As is well known, the process of installing shake siding on a wall of a building typically includes the steps of fixing a first horizontal row of shakes along the bottom of the wall by nailing or otherwise fastening individual shakes in at least two places adjacent lateral sides of the shake, approximately 10 inches or so up from the bottom of the shake. The shakes are usually installed in a side by side manner thus forming a first horizontal row shakes. It is common to nail the shakes to the wall of the building such that the nails 52 generally form a row as shown in FIG. 4. Each subsequent row of shakes is typically formed in a similar manner such that the next subsequent horizontal row of shakes partially overlaps the shakes comprising the first horizontal row of shakes. This process is then repeated for each subsequent horizontal row of shakes as the worker installs the shakes along the side wall of the building from the lowermost horizontal portion of the building to the uppermost horizontal portion of the building. In the following description, the shakes of two adjacent overlapping horizontal rows of shakes will be identified as the upper shakes 54 and the lower shakes 56. The lower shakes 56 are the shakes that form the lower first horizontal row of shakes and the upper shakes 54 are the shakes that form the subsequent upper horizontal row of shakes and partially overlap the lower first row, e.g., as noted above the upper shakes 54 partially overlap the lower shakes 56.

The shelf jig 2 is installed by laying at least the upper portion 12 of the main body 4 along an outer face 58 of one of the lower shakes 56 such that the rear face 18 of the main body 4 is substantially flush and parallel with the outer face 58 of the lower shake 56. In this position, the entire main body 4 is located vertically below a lower horizontal edge 60 of the upper shake 54. Next, the worker grasps the shelf jig 2, preferably by the aperture 34, and slides shelf jig 2 vertically upward, along the outer face 58 of the lower shake 56, such that the upper portion 12 of the main body 4 is inserted between the upper shake 54 and the partially overlapped lower shake 56. The shelf jig 2 continues sliding vertically upward generally until the retention spring 10 abuts against the lower end 60 of the upper shake 54 and thereby further prevents any upward sliding movement of the shelf jig 2 with respect to the upper shake 54. With no further vertical movement of the shelf jig 2 possible, the shelf jig 2 is considered to be in a fully installed position, as generally shown in FIG. 3A.

In the fully installed position, the upper portion 12 of the main body 4 is securely seated and sandwiched between the upper shake 54 and the lower shake 56 and such sandwiching generally securely retains the shelf jig 2 in an operative position. As indicated above, the upper portion 12 of the main body 4 functions as a clamping leg, e.g., that is, the upper portion 12 of the main body 4 is clamped between the upper shake 54 and the lower shake 56 and facilitates retention of the shelf jig 2.

To enhance the clamping force provided on the upper portion 12 of the main body 4 by the upper shake 54 and the lower shake 56, the upper portion 12 of the main body 4 typically comprises one or more gripping protrusions 20 which are located on at least one of the front face 16 and/or rear face 18 of the main body 4. The one or more gripping protrusions 20 are shaped, sized and designed so as to protrude from the front and/or rear faces of the main body 4 and suitably engage with the upper shake 54 and/or the lower shake 56. Preferably, the gripping protrusion(s) 20 protrude from the front and/or rear faces 16, 18 of the main body 4. The increase in the thickness of the upper portion 12 of the main body 4, due to the gripping protrusion(s) 20, generally enhances the gripping force with the upper and lower shakes 54, 56 on the upper portion 12 and thereby enhances retention of shelf jig 2 in the installed position, as shown in FIG. 3a.

Once the first shelf jig 2 is secured in the installed position described above, a second shelf jig 2′ is similarly installed in a spaced relationship to the first shelf jig 2, e.g., located between adjacent upper and lower shakes 54, 56 of the same two overlapping rows of shakes. As a result of this process, the first and the second shelf jigs 2, 2′ are horizontally spaced from one another typically by a distance of between 1 foot to about 8 feet or so, depending on the length of the shelf board 26 to be supported thereby and/or the building materials, supplies and/or tools to be supported during installation or during the maintenance or repair project. It is to be recognized that one could utilized more than two shelf jigs 2, 2′ when assembling the shelving system according to the teachings of the present invention. For example, three or more shelf jigs may be utilized for supporting longer shelf boards 26 and/or for supporting heavy loads of building materials, supplies and/or tools. As expected, the more shelf jigs 2 used to support the shelf board 26, the stronger and the more support provided by the shelving system. That is, a shelf board 26 that is support by three shelf jigs 2, 2′ is typically able support a greater amount of weight than a shelf board 26 that is only supported by two shelf jigs 2, 2′.

Once the first and the second shelf jigs 2, 2′ are secured in their installed spaced apart positions described above, the shelf board 26 can then be installed and secured thereto. Installation of the shelf board 26 generally occurs by laying and sliding the shelf board 26 along the upper top surface of upper top surface of the support plate 6 is substantially planar of the first and the second shelf jigs 2, 2′ and then sliding the shelf board 26 rearward (i.e., toward the respective main body 4) until the shelf board 26 generally abuts against the front faces 16 of the main bodies 4 of the first and the second shelf jigs 2, 2′. Once this occurs, the worker may choose to fasten the shelf board 26 to the first and second shelf jigs 2, 2′ by at least partially driving a screw or a nail 46 through the pre-drilled holes 44 in the retention springs 10 or the support plates 6 and into the shelf board 26. This measure of securing the shelf board 26 to the shelf jigs 2, 2′ generally minimizes the chance of slippage or other undesired movement of the shelf board 26 with respect either the first and/or the second shelf jigs 2, 2′ from occurring. With the shelf board 26 secured to the shelf jigs 2, 2′ and the shelf jigs 2, 2′ retained between the two overlapping horizontal rows of shakes 54, 56, the shelf system is now ready to support a desired load of building materials, supplies and/or tools.

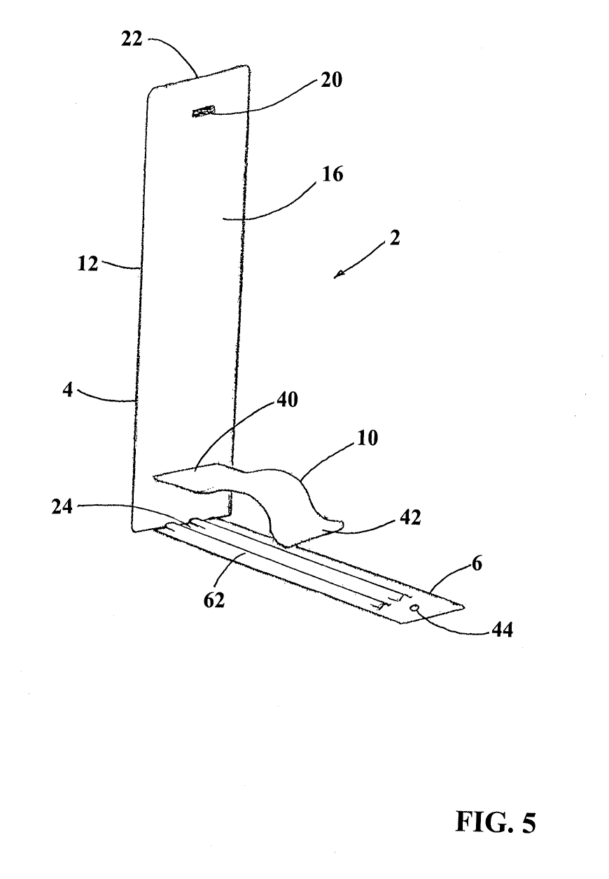

Turning now to FIG. 5, a second embodiment of the present invention will now be discussed. As this embodiment is similar, in many respects, to the previously discussed first embodiment, only the differences between the second embodiment and the first embodiment will be discussed in detail while identical elements will be give identical reference numerals in the drawings.

The major difference between this embodiment and the first discussed embodiment generally relates to the minimization, or general elimination, of the lower portion 14 of the shelf jig 2. That is, according to this embodiment, the upper portion 12 of the main body 4 and the support plate 6 are generally formed integral with one another as an integral L-shaped member such that the support plate 6 extends substantially normal to the main body 4. If desired, one or more ribs 62 or some other reinforcing member(s) may be provided for reinforcing the bottom surface of the support plate 6 and thereby facilitate the support plate 6 supporting a heavier load of building materials, supplies and/or tools. In addition, the pre-drilled holes 44 are formed in the support plate 6, adjacent the remote free end thereof. All other respects, the second embodiment is substantially similar to the first embodiment.

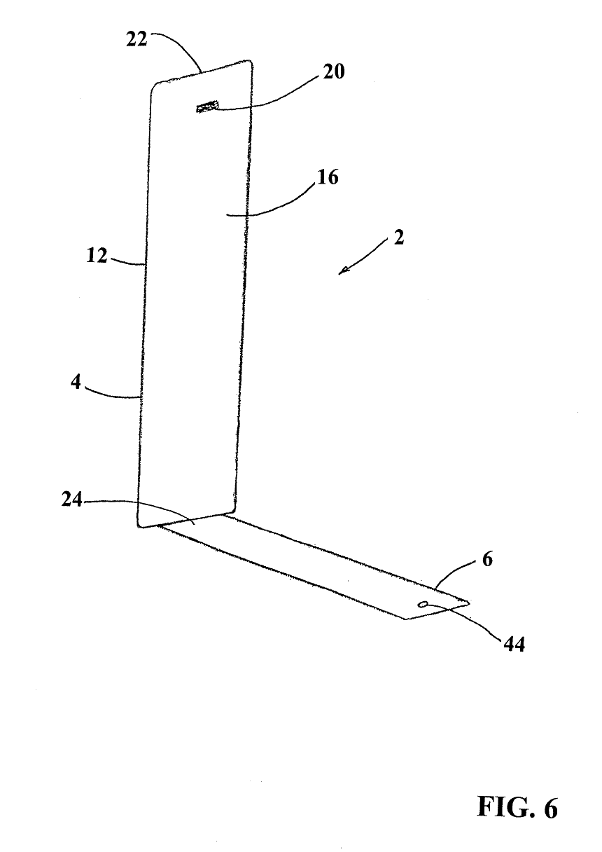

Turning now to FIG. 6, a third embodiment of the present invention will now be discussed. As this embodiment is quite similar, in many respects, to the second embodiment, only the differences between the third embodiment and the second embodiment will be discussed in detail while identical elements will be give identical reference numerals in the drawings.

The major difference between this embodiment and the first discussed embodiment generally relates to the elimination of the retention spring of the shelf jig 2. That is, according to this embodiment, as with the second embodiment, the upper portion 12 of the main body 4 and the support plate 6 are generally formed integral with one another as an integral L-shaped member such that the support plate 6 extends substantially normal to the main body 4. However, the retention spring 10 is eliminated and the shelf board 26 is supported by the upper surface of the support plate 6 and retained thereby solely via the pre-drilled holes 44 formed in the support plate 6, adjacent the remote free end thereof. In all other respects, the third embodiment is substantially similar to the second embodiment.

Preferably, the shelf jig 2 will be manufactured from a resilient material such as metal. It has been found that shelf jigs 2 formed from spring steel have a high resistance to bending and fatigue and is particularly suited for use with the present invention. It is also to be appreciated, however, that the shelf jig 2 can be manufactured from a variety of other materials, other than spring steel, e.g., such as conventional plastic or composites, or the like. In this regard, the important aspect of the shelf jig 2 is that it is sufficiently rigid and durable to facilitate retention of the shelf board 26 under a modest load.

The shelf board 26 preferably has a length of between about 1 foot to about 16 feet or so, and more preferably have a length of between about 2 feet to about 8 feet or so. It is to be appreciated that the length of the utilized shelf board 26 generally depends on the number of shelf jigs 2, 2′ to be utilized for supporting the shelving system and the amount of weight that will be eventually supported by the shelving system. If one were to utilize two shelf jigs 2, 2′ in the shelving system or if a heavy load is to be supported by the shelving system, it is preferable that the length of the shelf board 26 does not exceed about 8 feet or so. If three or more shelf jigs 2, 2′ were to be used in the shelving system, the length of the shelf board 26 could be as great a 16 feet and support a greater load.

It is further to be appreciated that the shelf board 26 can be manufactured from a variety of materials such as wood, wood composites, plastic, metals, etc. The shelf board 26, as shown in FIGS. 3A and 4, is depicted as being a lightweight wooden board having a constant thickness of approximately ¾ inch or so, and also having a width of between about 5 inches to about 8 inches or so.

In the above description and appended drawings, it is to be appreciated that only the terms “consisting of” and “consisting only of” are to be construed in the limitative sense while of all other terms are to be construed as being open-ended and given the broadest possible meaning.

Since certain changes may be made in the above described shelving system, without departing from the spirit and scope of the invention herein involved, it is intended that all of the subject matter of the above description or shown in the accompanying drawings shall be interpreted merely as examples illustrating the inventive concept herein and shall not be construed as limiting the invention.

Wherefore, we claim:

1. A shelf system for supporting a load along a wall having overlapping horizontal rows of siding members, the shelf system comprising a pair of shelf jigs, and each shelf jig comprising:
an elongate planar main body and an elongate planar support plate, one end of the support plate being integral with the main body, the support plate extending at least substantially normal from the main body; and
a shelf board being supported by the support plates of the pair of shelf jigs to form a shelf.

2. The shelf system according to claim 1, wherein each shelf jig has a securing means for securing the shelf board to the support plate.

3. The shelf system according to claim 1, wherein each shelf jig has a brace member that is integral with at least the support plate and which enhances rigidity of the support plate with respect to the main body.

4. The shelf system according to claim 1, wherein each shelf jig has a securing means which facilitates securing the shelf board to the support plate and a brace member that is fixed to at least the support plate and which enhances rigidity of the support plate with respect to the main body,
the support plate is integral with and extends from a lower portion of the main body and the brace member comprises a first surface that is fixed to the support plate and a second surface that is fixed to the main body, and
the securing means is a retention spring which applies a clamping force on the shelf board in a direction of the support plate.

5. A shelf system for supporting a load along a wall having overlapping horizontal rows of siding members, the shelf system comprising a pair of shelf jigs, and each shelf jig comprising:
a planar main body having at least an upper portion and front and rear faces:
a planar support plate being fixedly supported by the main body and extending approximately normal to the front face of the main body; and
a retention spring being fixed to and extending from the front face of the main body substantially parallel to the support plate, an end of the retention spring that is remote from the main body is closer to the support plate than an end of the retention spring that is fixed to the main body such that the remote end of the retention spring applies a clamping force to a shelf board when the shelf board is located between the retention spring and the support plate to facilitate retention of the shelf board.

6. The shelf system according to claim 5, wherein the main body further comprises a lower portion, and a brace member interconnects the lower portion of the main body with the support plate for supporting the support plate.

7. The shelf system according to claim 5, wherein a first edge of the brace member is fixed to a bottom surface of the support plate and a second edge of the brace member is fixed to the front face of the lower portion of the main body.

8. The shelf system according to claim 5, wherein each of the shelf jigs further includes an insertion/retraction element which assists with insertion and retraction of the shelf jig from between two overlapping siding members.

9. The shelf system according to claim 6, wherein the brace member includes an aperture which assists with insertion and retraction of the shelf jig from between two overlapping siding members.

10. The shelf system according to claim 6, wherein the brace member is one of rounded, beveled or coated with a protective material around the perimeter of the aperture.

11. The shelf system according to claim 5, wherein the upper portion of the main body includes at least one gripping protrusion which facilitates retention of the shelf jig during use.

12. The shelf system according to claim 6, wherein the brace member is generally triangularly in shape and enhances an overall rigidity and integrity of the support plate with respect to the main body.

13. The shelf system according to claim 6, wherein the brace member supports at least one attachment element which facilitates receiving and retaining at least one of an electrical cable, a pneumatic hose, a nail gun or a jig saw.

14. The shelf system according to claim 13, wherein the at least one attachment element comprises a hook which is pivotably supported by the brace member.

15. The shelf system according to claim 5, wherein at least one of a remote end of the shelf retention spring and a remote end of the support plate includes at least one pre-drilled hole which facilitates fastening the shelf board to the shelf jig via a conventional fastener.

16. The shelf system according to claim 5, wherein the shelf jig has a width of between ¼ inch and about 5 inches and the main body and the support plate have a thickness of between about 1/32 inch and about ⅛ inch and the shelf jig has a length of between 3 inches to about 12 inches.

17. The shelf system according to claim 5, wherein the retention spring has first and second ends, the first end of the retention spring being fixed to the front face of the main body between a top surface of the support plate and the upper end of the main body, the retention spring extends from the main body substantially parallel to the support plate, the second end of the retention spring being spaced at a distance from the top surface of the support plate such that the second end of the retention spring applies a clamping force on a shelf board when the shelf board is located between the retention spring and the top surface of the support plate

18. A method of supporting a load with a shelf system along a wall having either shake or shingle siding, the shelf system comprising a shelf board and at least a pair of shelf jigs, each of the shelf jigs having a planar main body with upper and lower ends and front and rear faces, a planar support plate being fixed at an approximately normal angle to the front face of the main body such that the support plate extends laterally between lateral edges of the main body, a brace member having a first edge that is fixed to a bottom surface of the support plate and a second edge that is fixed to the front face of the main body to brace the support plate with respect to the main body, and a retention spring that is fixed to the front face of the main body between a top surface of the support plate and the upper end of the main body, the method comprising the steps of:
laying at least the upper end of the main body of a first shelf jig on an outer face of at least one lower shake of a lower row of shakes such that a rear face of the main body is substantially flush and parallel with an outer face of the at least one lower shake;
inserting the upper end of the main body between an inner face of at least one upper shake of an upper row of shakes and the outer face of the at least one lower shake by sliding the first shelf jig along the outer face of the at least one lower shake toward the at least one upper shake until the upper end of the main body is secured between the at least one upper shake and the at least one lower shake;
laying at least the upper end of the main body of a second shelf jig on an outer face of at least one other lower shake of the lower row of shakes laterally spaced from the first shelf jig such that a rear face of the main body of the second shelf jig is substantially flush and parallel with an outer face of the at least one other lower shake;
inserting the upper end of the main body of the second shelf jig between an inner face of at least one other upper shake of the upper row of shakes laterally spaced from the first shelf jig and the outer face of the at least one other lower shake by sliding the second shelf jig along the outer face of the at least one other lower shake toward the at least one other upper shake until the upper end of the main body of the second shelf jig is secured between the at least one other upper shake and the at least one other lower shake; and
inserting the shelf board between the retention springs and the top surface of the support plates of the first and the second shelf jigs.

19. The method of supporting a load according to claim 18, further comprising the step of inserting a fastener through a pre-drilled hole in at least one of the shelf retention springs and the support plates of the first and the second shelf jigs and into the shelf board to secure the shelf board to the first and the second shelf jigs.
